(19) United States
(12) Patent Application Publication
(10) Pub. No.: US 2018/0044835 A1
(43) Pub. Date: Feb. 15, 2018

(54) Vibration-Isolator Platform

(71) Applicant: Seicon Limited, Hilliard, OH (US)

(72) Inventor: James A. Baron, Hilliard, OH (US)

(73) Assignee: Seicon Limited, Hilliard, OH (US)

(21) Appl. No.: 15/673,370

(22) Filed: Aug. 9, 2017

Related U.S. Application Data
(60) Provisional application No. 62/372,471, filed on Aug. 9, 2016.

(51) Int. Cl. D06F 37/22; D06F 39/12; F16M 5/00

(52) U.S. Cl. CPC D06F 37/22; F16M 5/00; D06F 39/125

(57) ABSTRACT

A collapsible platform for supporting a device such as a vibration source includes a pair of spaced-apart platform members each having at least one upward-facing support surface for partially supporting the vibration source, at least one base member configured to rest on a generally horizontal support surface and to support the pair of platform members, and at least one cross member extending between the pair of platform members and fixed to each of the pair of platform members to fix a separation distance between the platform members.

### CROSS-REFERENCE TO RELATED APPLICATIONS

This application claims the priority benefit of U.S. Provisional Patent Application No. 62/372,471 filed on Aug. 9, 2016, the disclosure of which is expressly incorporated herein in its entirety by reference.

### STATEMENT REGARDING FEDERALLY SPONSORED RESEARCH

Not applicable

### PARTIES TO A JOINT RESEARCH AGREEMENT

Not Applicable

### REFERENCE TO APPENDIX

Not applicable

### FIELD OF THE INVENTION

The field of the present invention relates to structures that support and isolate vibration originating from an object that is supported by the structure, and more particularly, to such structures that support and isolate vibration from machines for industrial or consumer use including but not limited to automatic washing machines.

### BACKGROUND OF THE INVENTION

Washing machines, air conditioners, and other machines frequently cause noise and/or vibration during operation. Conventional washing machines, for example, employ dampers between the vibrating drum and the frame. Some of the vibrational energy is lost as heat while the rest is transmitted to the frame. User response to this transmitted vibration or noise may range from minor annoyance to major aggravation.

Noise and vibration problems may be exacerbated when the machines are placed in locations close to living or sleeping areas; noise or vibration from a first floor laundry room is more likely to disrupt conversations, television watching, or the like in other first floor rooms than noise or vibration from a basement laundry room. Similarly, noise from or vibration from a second floor laundry room is more likely to disrupt sleep than noise from a laundry room located on a different level. Noise and vibration problems also may originate from machines operated by others when individuals work or reside in close proximity to others, as is frequently the case in urban environments and attached residences.

Noise and vibration problems also may be exacerbated when machines are installed in locations that tend to transmit rather than disperse vibration. Washing machines on upper building floors (i.e., not on a basement or slab floor) may readily transit noise and vibration throughout the building. Air conditioners installed on platforms extending from the wall of the building rather than on a concrete pad may also transmit noise and vibration.

Excessive vibration also may cause disruption or damage in addition to adversely affecting user comfort, particularly with machines that include rotating shafts. Excessive vibration also may result in movement of the machine relative to the support surface, which in turn may cause problems including disruption of machine operation or physical damage. Movement of the machine relative to its support can disrupt machine operation, mark or tear finished flooring, or cause water damage if a water supply hose is damaged or disconnected. The forces associated with rotating shafts also may cause damaging movement or vibration of the machine structures that support the shafts and retain them in position.

Manufacturers of machines such as washers and air conditioners have endeavored to produce quieter units but have not consistently achieved success. Machines that exhibit satisfactory performance in an idealized test situation may nevertheless cause undesirable noise and vibration if they are located in an environment that does not allow the vibration to dissipate. Traditional damping methods such as placement of elastomeric or similar pads under the machine also have had only limited success.

Attempts have been made to reduce the transmission of vibrations from the vibration source to the surrounding environment. With regard to front-loading washing machine, the most common solution has been to sit the washing machine on a rubber mat or the like. While this may reduce the transmission of vibrations somewhat, the reduction is much less than desired. U.S. Pat. Nos. 8,196,910 and 8,266,929, the disclosures of which are expressly incorporated herein in their entireties by reference, disclose platform and pedestal isolators that reduce the transmission of vibrations as much as 95% or more. They also effectively isolate vibration at all stages of operation of the vibration source, allow movement of the appliance from one location to another if desired, are usable with a wide range of appliance brands and models, and are relatively inexpensive.

However, while these platforms or pedestal vibration isolators effectively reduce the transmission of vibrations from the vibration source to the surrounding environment, they are relatively large and heavy which can impact shipping and storage. Accordingly, there exists a need for a vibration isolator that effectively isolates vibration at all stages of operation of the vibration source, allows movement of the appliance from one location to another if desired, is usable with a wide range of appliance brands and models, is relatively inexpensive, and is relatively small and lightweight.

### SUMMARY OF THE INVENTION

The present invention provides platforms which address at least one of the above-noted problems of the prior art. Disclosed herein is a platform comprising a pair of spaced-apart platform members each having at least one upward-facing support surface, at least one base member configured to rest on a generally horizontal support surface and to support the pair of platform members, and at least one cross member extending between the pair of platform members and fixed to each of the pair of platform members to fix a separation distance between the platform members.

Also disclosed herein is a vibration-isolator platform for supporting a vibration source comprising a pair of laterally spaced-apart platform members each having at least one upward-facing support surface for partially supporting the vibration source, at least one base member configured to rest on a generally horizontal support surface and to support the pair of platform members with a plurality of rod assemblies, at least one cross member extending between the pair of platform members and fixed to each of the pair of platform members to fix a separation distance between the platform members. The plurality of rod assemblies operably connect the platform members to the at least one base member and are configured to substantially isolate the at least one base member from vibration at the platform members.

Also disclosed herein is a vibration-isolator platform in combination with a front-loading washing machine. The front-loading washing machine has a horizontally disposed spinning axis. The vibration-isolator platform comprises a pair of laterally spaced-apart platform members each having at least one upward-facing support surface for partially supporting the front-loading washing machine, at least one base member configured to rest on a generally horizontal support surface and to support the pair of platform members with a plurality of rod assemblies, and at least one cross member extending between the pair of platform members and fixed to each of the pair of platform members to fix a separation distance between the platform members. The plurality of rod assemblies operably connect the platform members to the at least one base member and are configured to substantially isolate the at least one base member from vibration at the platform members.

From the foregoing disclosure and the following more detailed description of various preferred embodiments it will be apparent to those skilled in the art that the present invention provides a significant advance in the technology and art of vibration isolation systems. Particularly, significant in this regard is the potential the invention affords for providing a reliable, inexpensive, and effective vibration isolation system for front-loading washing machines that is also relatively small and lightweight. Additional features and advantages of the invention will be better understood in view of the detailed description provided below.

### BRIEF DESCRIPTION OF THE DRAWINGS

These and further objects of the invention will become apparent from the following detailed description.

FIG. 1 is a perspective view of a vibration-isolator platform according to a first embodiment of the present invention.

FIG. 2 is an exploded perspective view of the vibration-isolator platform of FIG. 1.

FIG. 3 is an exploded perspective view of a base and rod assembly of the vibration-isolator platform of FIGS. 1 and 2.

FIG. 4 is a perspective view of a variation of the vibration-isolator platform of FIGS. 1 to 3.

FIG. 5 is an exploded perspective view of the vibration-isolator platform of FIG. 4.

FIG. 6 is a perspective view of a vibration-isolator platform according to a second embodiment of the present invention.

FIG. 7 is an exploded perspective view of the vibration-isolator platform of FIG. 6.

FIG. 8 is a perspective view of a vibration-isolator platform according to a third embodiment of the present invention.

FIG. 9 is a top plan view of the vibration-isolator platform of FIG. 8.

FIG. 10 is a rear elevational view of the vibration-isolator platform of FIGS. 8 and 9.

FIG. 11 is a left-side elevational view of the vibration-isolator platform of FIGS. 8 to 10.

FIG. 12 is an exploded perspective view of the vibration-isolator platform of FIGS. 8 to 11.

FIG. 13 is a front loading washing machine supported on top of the vibration-isolator platform of FIGS. 8 to 12.

FIG. 14 is an exploded perspective view of a variation of the vibration-isolator platform of FIGS. 8 to 13.

FIG. 15 is a front-loading dryer supported on top of the vibration-isolator platform of FIG. 14.

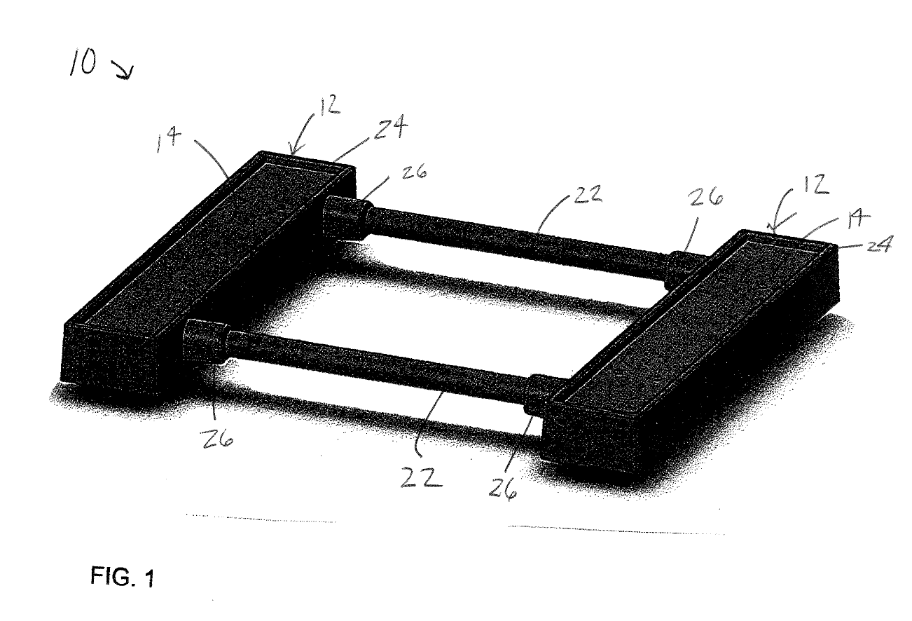

It should be understood that the appended drawings are not necessarily to scale, presenting a somewhat simplified representation of various preferred features illustrative of the basic principles of the invention. The specific design features of the various isolators as disclosed herein, including, for example, specific dimensions, orientations, locations, and shapes will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the isolators illustrated in the drawings. In general, up or upward generally refers to an upward direction in FIG. 1 and down or downward generally refers to a downward direction in FIG. 1. Also in general, fore or forward generally refers to a direction out of the page in FIG. 1 and aft or rearward generally refers to a direction into the page in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the pedestals disclosed herein. The following detailed discussion of various alternative and preferred embodiments will illustrate the general principles of the invention with regard to the specific application of pedestals for laundry machines such as clothes washers and clothes dryers. Other embodiments suitable for other applications will be apparent to those skilled in the art given the benefit of this disclosure.

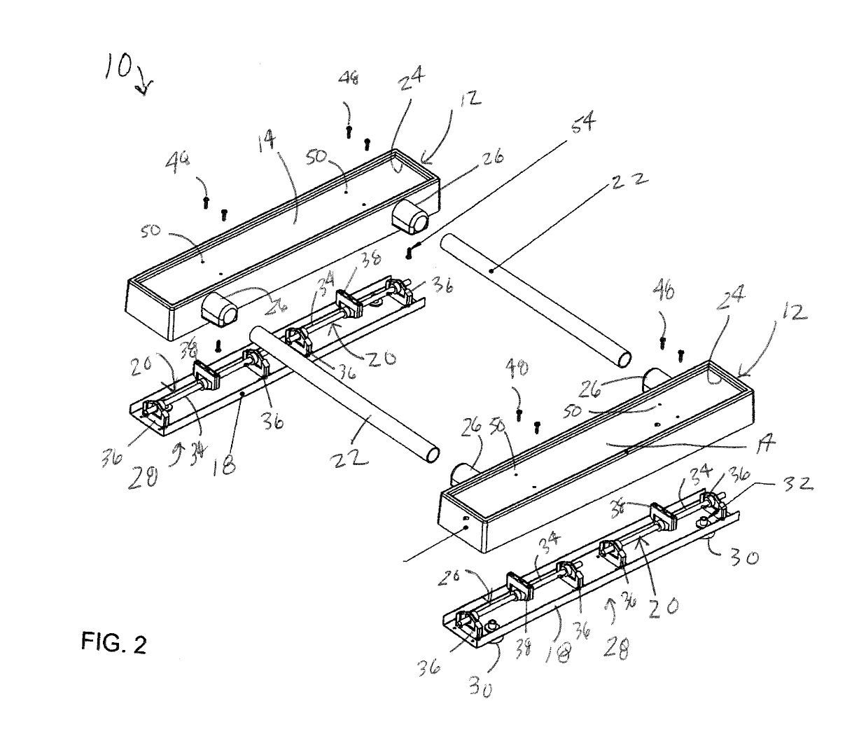

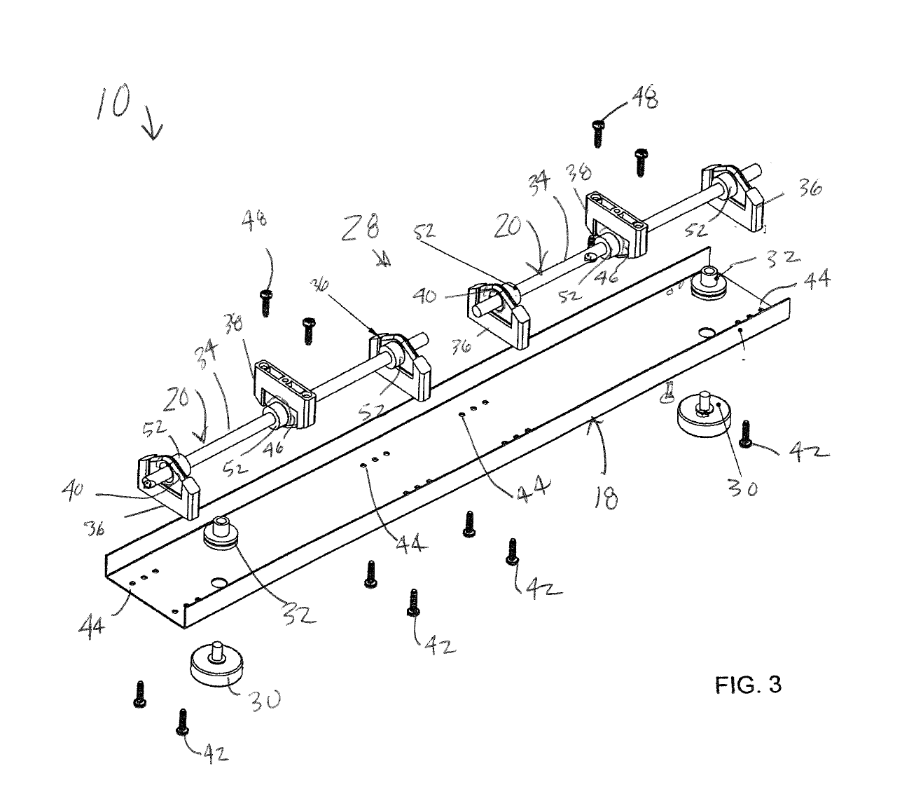

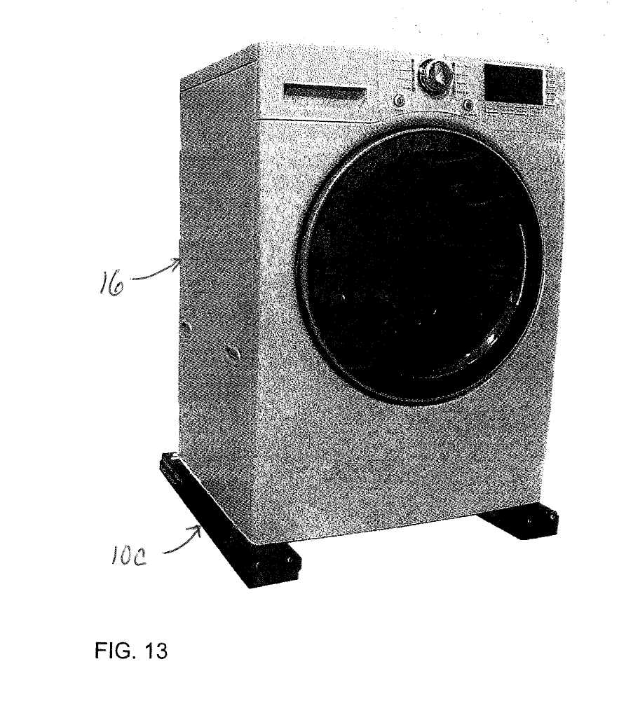

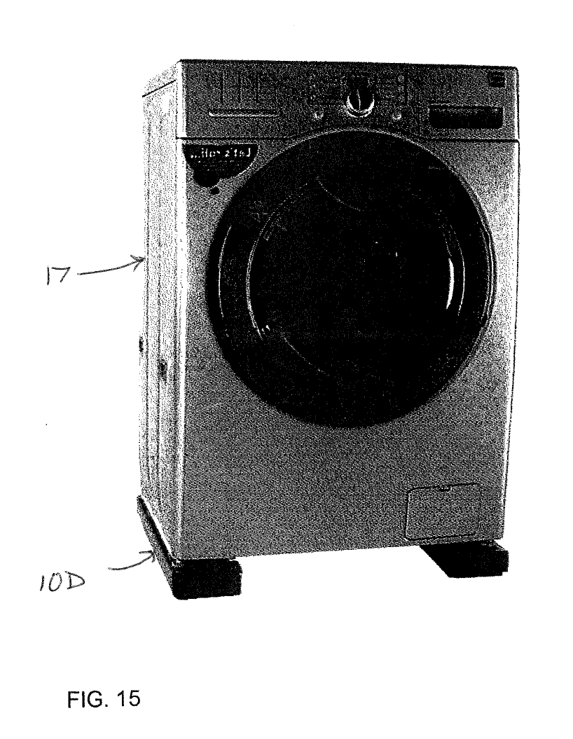

FIGS. 1 to 3 illustrate a collapsible platform assembly or platform 10 according to a first embodiment of the present invention. The illustrated collapsible platform 10 is a vibration isolation platform and includes a pair of separate, laterally spaced-apart and parallel, elongate platform members 12 extending in the forward/rearward direction and each having at least one upward-facing support surface 14 for partially supporting a vibration source 16 such as a front-loading clothes washing machine (see FIG. 13) or other device 17 such as a front-loading clothes dryer (see FIG. 15), at least one base member 18 configured to rest on a generally horizontal support surface such as the floor or ground and to support the pair of elongate platform members 12 with a plurality of rod assemblies 20 operably connecting the elongate platform members 12 to the at least one base member 18 and configured to substantially isolate the at least one base member 18 from vibration of the elongate platform members 12 caused by the vibration source 16 supported thereon, and at least one spreader or cross member 22 extending between the pair of elongate platform members 12 and secured to each of the pair of elongate platform members 12 to selectively fix a separation distance between the space-apart and parallel elongate platform members 12. The illustrated vibration-isolator platform 10 includes a pair of the base members 18 (each associated with a different one of the elongate platform members 12) and a pair of the cross members 22 but any other suitable quantity of one or more can alternatively be utilized for either or both of the at least one base member 18 and the at least one cross member 22.

The illustrated elongate platform members or rail covers 12 are each generally elongate having a longitudinal axis extending in a forward/rearward direction and having a horizontally-extending and rectangular-shaped top wall, a vertically-extending and rectangular-shaped outer wall downwardly extending from an outer edge of the top wall, a vertically-extending and rectangular-shaped inner wall downwardly extending from an inner edge of the top wall opposed to and parallel to the outer wall, a vertically-extending and rectangular-shaped front wall downwardly extending from a front edge of the top wall and connecting front edges of the outer an dinner walls, and a vertically-extending and rectangular-shaped rear wall downwardly extending from a rear edge of the top wall, connecting rear edges of the inner and outer walls, and opposed to and parallel to the front wall. The top, outer, inner, front, and rear walls collectively form a hollow interior space that it open at its bottom side to cooperate with one of the base members 18 as described in more detail herein below.

The top of the illustrated top wall forms the at least one upward-facing support surface 14 for partially supporting the vibration source 16. The illustrated elongate platform members 12 are configured to support a washing machine having four feet. The left side elongate platform member 12 supports the front and rear left two of the feet of the washing machine which directly rests on the support surface 14. While the right side elongate platform member 12 supports the front and rear right two of the feet of the washing machine which directly rests on the support surface 14. The illustrated support surface 14 is horizontally extending, that is substantially flat, and is substantially the same size as the top wall except for an upwardly extending lip 24 along the edges of the top wall and about the periphery of the support surface 14 so that the support surface 12 is recessed. The lip 24 is configured to prevent the feet of the washing machine from vibrating off of the support surface 14 as the washing machine is supported thereon but is not connected thereto. The illustrated elongate platform member 12 is also provided with a pair of sockets 26 laterally extending inward from the outer side of the inner wall. The illustrated sockets 26 are at the same height and are parallel and spaced apart in the forward and rearward directions. The sockets 26 are configured to receive ends of the cross members 22 therein as described in more detail hereinafter. The illustrated sockets 26 include a cylindrically-shaped cavity for receiving the cross-members 22 but the cavities can alternatively have any other suitable shape. The socket cavities are preferably reamed to provide a close tolerance fit with the cross members 22. The illustrated elongate platform members 12 are molded of a thermoset plastic but it is noted that any suitable material and/or forming method can alternatively be utilized. It is also noted that the elongate platform members 12 can alternatively have any other suitable configuration.

The illustrated vibration-isolator platform 10 includes a pair of rod and base assemblies 28 each including one of the base members 18 and a pair of the rod assemblies 20 operably secured to the base member 18. The illustrated base member 18 is generally elongate and channel shaped having a longitudinal axis extending in a forward/rearward direction and are configured to be located below one of the platform members 12 and at least partially extending into the hollow cavity of the platform member 12 through the bottom opening. The illustrated base members 18 are sized so that they do not outwardly extend beyond the walls of the platform member 12 in any direction except in the downward direction.

The illustrated base member 18 is channel shaped having a horizontally-extending and rectangular-shaped main wall, a vertically-extending and rectangular-shaped outer wall upwardly extending from an outer edge of the main wall, and a vertically-extending and rectangular-shaped inner wall upwardly extending from an inner edge of the top wall opposed to and parallel to the outer wall. The illustrated base members 18 are formed by bending sheet metal such as, for example, 16 gauge steel but it is noted that any suitable material and/or forming method can alternatively be utilized. The illustrated base member 18 is also provided with a pair of feet 30 downwardly extending from the main wall configured to rest on the generally horizontal support surface such as, for example, a floor or the like. The illustrated pair of feet 30 are spaced-apart in the longitudinal direction a suitable direction so that the washing machine can rest on the illustrated vibration-isolator platform 10 in a stable manner. The illustrated feet 30 are each individually adjustable by having an upwardly extending threaded rod which cooperates with an internally-threaded passage of a rivet nut 32 secured to the main wall. The illustrated rivet nut 32 is a one-piece internally-threaded and counter-bored tubular rivet that can be anchored to the main wall entirely from one side. The foot 30 can be threaded further into and/or further out of the out of the rivet nut 32 to adjust the height of the foot 30 and thus the height of the vibration-isolator platform 10 can be adjusted and leveled. It is noted that the feet 30 can alternatively have any other suitable configuration with or without height adjustability. It is also noted that the base member 18 can alternatively have any other suitable configuration.

Each of the illustrated rod assemblies 20 include an elongate flexible rod 34 having opposing end portions and a central portion intermediate the end portions, a pair of end supports 36 engagingly supporting the end portions of the elongate flexible rod 34 respectively, and a center support 38 engagingly supporting the central portion of the elongate flexible rod 34. The end supports 36 are secured to one of the base member 18 and the platform member 12 and the central support 38 is secured to the other of the base member 18 and the platform member 12. The illustrated end supports 36 are secured to the top of the main wall of the base member 18 in a longitudinally spaced apart manner in the forward/rearward direction and the illustrated central support 38 is secured to the bottom of the top wall of the platform member 12. Mounted in this manner, the pair of rod assemblies 20 support the platform member 12 above the base member 18 and operably connect the platform member 12 to the base member 18 to substantially isolate the base member 18 from vibration at the platform member 12.

The illustrated end supports 36 are each generally block shaped and include a bushing 40 for passage of the elongate flexible rod 34 therethrough and for support of the elongate flexible rod 34. The bottom side of each illustrated end support 36 is provided with a pair of laterally spaced-apart threaded openings that received threaded fasteners 42 upwardly extending through a pair of laterally spaced-apart fastener openings 44 in the main wall of the base member 18 to rigidly secure the end support 36 to the main wall of the base member 18. It is noted that the end support 36 can alternatively have any other suitable configuration and/or be secured to the base member 18 in any other suitable manner.

The illustrated base member 18 is provided with a plurality of pairs of the fastener openings 44 that are longitudinally spaced apart in the forward rearward direction to enable the end support 36 to alternatively be secured to the base member 18 in one of a plurality of positions. The illustrated base member 18 is provided with three pairs of the fastener openings 44 that are longitudinally spaced apart to enable the end support 36 to be alternatively secured to the base member 18 in three different positions. The plurality of the pairs fastener openings 44 enable the spacing between the end supports 36 to be configured for elongate flexible rods 34 having different lengths. For example, the spacing between the end supports 36 is configured for alternatively using elongate flexible rods having a length of 9 inches, 10 inches, or 11 inches to accommodate different loads of the vibration source 16 such as, for example, varying washing machine weights. It is noted that the spacing between the end supports 36 can alternatively be varied in any other suitable manner. The end supports 36 can be formed of any suitable material.

The illustrated center supports 38 are each generally block shaped and include bushing 46 for passage of the elongate flexible rod 34 therethrough and for support of the platform member 12 and other load on the elongate flexible rod 34. The top side of each illustrated center support 38 is provided with a pair of laterally spaced-apart threaded openings that receive threaded fasteners 48 downwardly extending through a pair of laterally spaced-apart fastener openings 50 in the top wall of the platform member 12 to rigidly secure the center support to the top wall of the platform member 12. It is noted that the center support 38 can alternatively have any other suitable configuration and/or be secured to the platform member 12 in any other suitable manner. The center supports 38 can be formed of any suitable material.

The illustrated rod assemblies 20 each also include collars 52 secured to the elongate flexible rod 34 to limit the movement of the elongate flexible rod 34 in a longitudinal direction (i.e., along the long axis of the elongate flexible rod 34) but still permit the elongate flexible rod 34 to flex when the platform member 12 vibrates. The illustrated rod assemblies 20 each include four of the collars 52 with two of the collars 52 located on the elongate flexible rod 34 near opposite sides of the center support 38 and two of the collars 52 located on the elongate flexible rod 34 near inner sides of the end supports 36. It is noted that any other suitable quantity and/or configuration of collars 52 can alternatively be utilized. The illustrated collars 52 are aluminum compression collars secured to the elongate flexible rod 34 with set screws but any other suitable collar can alternatively be utilized and/or any other suitable means for limiting the movement of the elongate flexible rod 34 in a longitudinal direction can alternatively be utilized.

The elongate flexible rods 34 may be shafts, plates, beams, or any other suitable elongated structure. The illustrated rods 34 have a circular-shaped cross section and are believed to yield superior results in some applications but other cross sectional shapes or structural forms may be preferred in other applications. The elongate flexible rods 34 may be constructed from any suitable material including but not limited to fiberglass-reinforced epoxy and other composite materials. The configuration and composition of the elongate flexible rods 34 may vary with the vibrational frequencies to be isolated and the environmental demands of the location where the vibration-isolator platform 10 is used.

The quantity and arrangement the rod assemblies 20 is such that the elongate flexible rods 34 are positioned to support the size and weight of the platform members 12 and the vibration source 16 supported thereon and respond to the expected vibration frequencies of the vibration source 16 to substantially isolate the at least one base member 18 from vibration at the platform members 12. The illustrated vibration-isolator platform 10 includes four of the rod assemblies 20 so that the vibration source 16 is supported by four of the elongate flexible rods 34. It is noted, however, that at any other suitable quantity of the rod assemblies 20 can alternatively be utilized. The illustrated elongate flexible rods 34 are each supported in substantially the same horizontal plane but can alternatively be supported in different horizontal planes when desired. The illustrated elongate flexible rods 34 also each extend in substantially the same longitudinal or forward/rearward direction so that the elongate flexible rods 34 extend parallel to the spinning axis of a front-loading washing machine. The elongate flexible rods 34, however, can alternatively be supported in more than one direction when desired.

The illustrated pair of cross members or spreader tubes 22 are each a rigid hollow tube having a fixed length which is sized to provide the desired separation distance between the platform members 12 and thus a desired lateral width of the vibration-isolator platform 12. Thus, the width of the vibration-isolator platform 10 can be changed by installing cross members 22 of a different length. For example, cross members 22 having a first length can be provided for adapting the vibration-isolator platform 10 for use with a 24 inch washing machine and cross members 22 having a second length (longer than the first length) can be provided for use with a 27 inch washing machine. The illustrated cross members 22 are circular in cross section but any other suitable shape can alternatively be utilized. The cross members can be formed of any suitable material. Ends of the illustrated pair of cross members 22 are located within the sockets 26 of opposed platform members 12 so that the cross members laterally extend and are substantially parallel and spaced apart in the forward rearward direction to rigidly connect the pair of platform members 12 and provide a desired lateral width for the platform 10. The illustrated cross members 22 are rigidly but removably secured to the sockets 26 with locking screws 54 but can be secured in any other suitable manner such as, for example, a ball lock pin and cooperating holes for snap-in convenience. It is noted that any other suitable quantity and/or configuration for the cross members 22 can be alternatively utilized.

The illustrated vibration-isolator platform 10 can be packaged for storage and shipment in a container with the cross members 22 disconnected from the platform members 12 so that the container size can be greatly reduced. The user can assemble the illustrated vibration-isolator platform 10 by simply removing the components from the container and installing the two cross members 22 between the platform members 12 with the locking screws 54. The illustrated two cross members 22 are installed by inserting the ends of the tubes into the opposed sockets 26 and then installing one of the locking screws 54 at each of the sockets 26 into to rigidly secure the tubes to the platform members 12. It is noted that the container can include a single pair of cross members 22 to establish a single desired lateral width for the vibration-isolator platform such as a suitable width such as for a 24 inch washing machine or a 27 inch washing machine or the container can include two or more pairs of cross members 22 each having a different fixed length to alternatively be installed to establish different desired lateral widths for the vibration-isolator platform such as a suitable width for a 24 inch and a suitable width for a 27 inch washing machine.

Once the vibration-isolator platform is assembled and positioned at its desired location with the feet 30 of the base members 18 supporting the vibration-isolator platform 10 on a substantially horizontal support surface such as a floor, the washing machine can be placed on top of the vibration-isolator platform 10 with the feet of the washing machine resting on the support surfaces 14 of the platform members. In the illustrated embodiments, the two feet on each of the lateral sides of the washing machine are supported on a respective one of the two opposed platform members 12. During operation of the washing machine, as vibration is produced by the washing machine, the elongate flexible rods 34 resiliently bow down and/or up to substantially isolate the base members 18 from the vibrations produced by the washing machine. It is noted that mobility or movement of the washing machine 16 during operation increases as a result of the softness of the vibration-isolator platform 10 as the elongate flexible rods 34 resiliently bow as the washing machine 16 and the platform members 12 move. With the orientation of the elongate flexible rods 34 parallel to each other and the spin axis of the front-loading washing machine, lateral mobility of the washing machine is reduced in the vertical plane perpendicular to the longitudinal axes of the elongate flexible rods 34. Other configurations for the elongate flexible rods 34 can be used control the mobility in other manners.

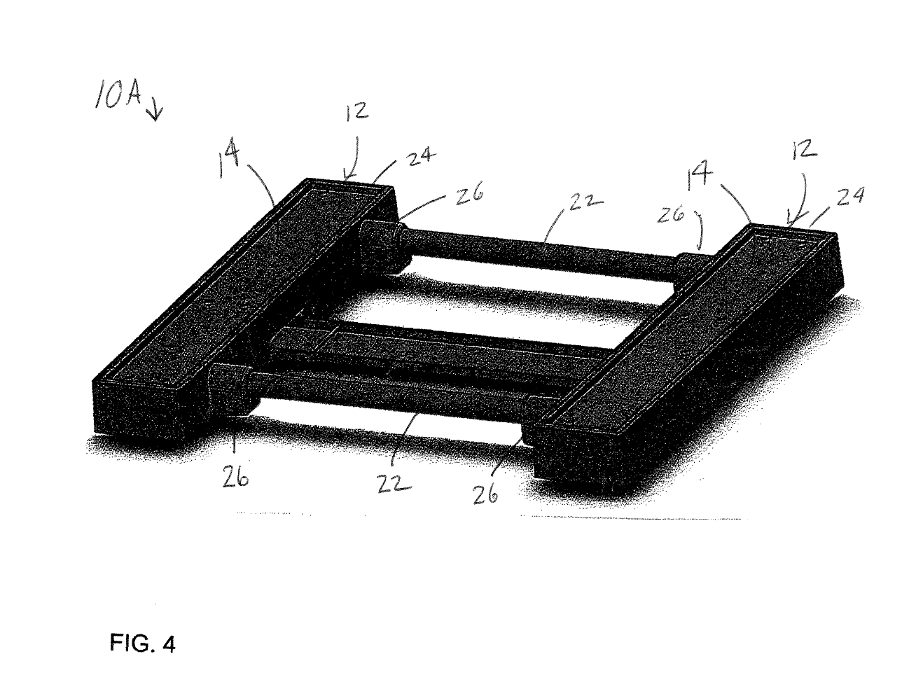

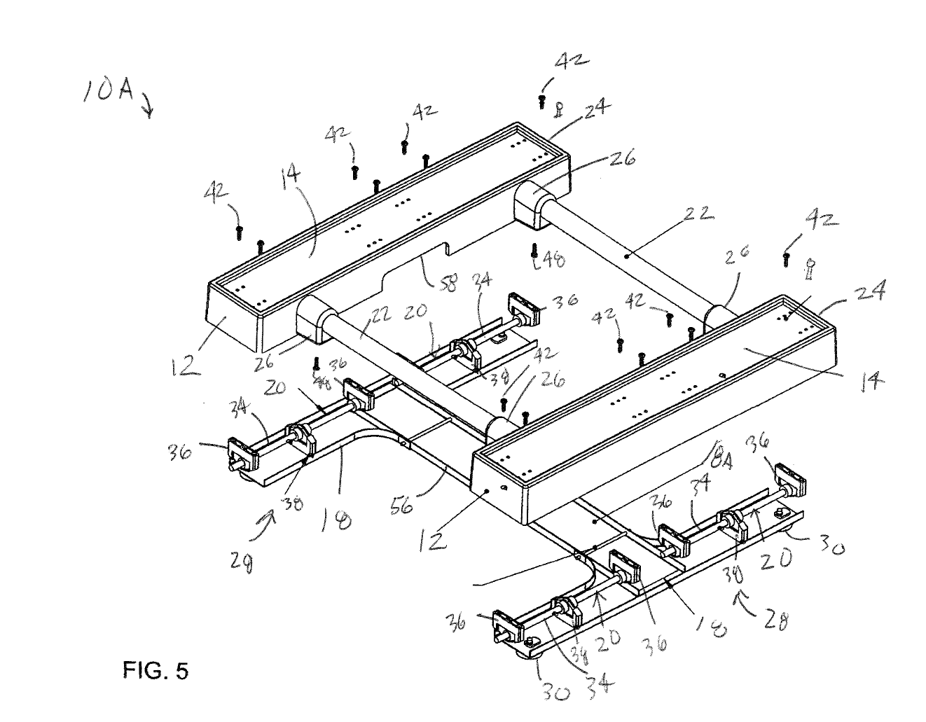

FIGS. 4 and 5 illustrate a vibration-isolator platform 10A that is a variation of the vibration-isolator platform 10 according to the first embodiment of the present invention described above. This variation of the vibration-isolator platform 10A is substantially the same as the vibration-isolator 10 platform according to the first embodiment of the present invention described above except that there is a single base member 18, and the rod assemblies 20 are inverted.

The illustrated single base member 18A includes a pair of the base member portions 18 and a base spreader portion 56 connecting the base member portions 18. The illustrated base member portions 18 are substantially the same as the above-described base members 18 except that the inner walls are each provided with a central connection for receiving a respective end of the base spreader portion 56 so that the base spreader portion 56 rigidly connects the base member portions 18. The illustrated base spreader portion 56 extends in the lateral direction perpendicular to the base member portions 18 and extends between the base member portions 18. The illustrated platform members 12 are each provided with a clearance notch 58 at the lower edge of the inner wall so that the base spreader bar portion 56 can pass therethrough without contacting the platform member 12. The illustrated base spreader portion 56 is channel shaped having a horizontally-extending and rectangular-shaped main wall, a vertically-extending and rectangular-shaped front wall upwardly extending from a front edge of the main wall, and a vertically-extending and rectangular-shaped rear wall upwardly extending from a rear edge of the top wall opposed to and parallel to the front wall. The illustrated base spreader portion 56 has a length that extends over the main walls and substantially entirely between the outer walls of the base member portions and is secured to each of the base member portions with a locking pin to form a rigid single piece base member. It is noted that the base spreader portion 56 is separate and attachable in order to reduce the container size during storage and shipping. During assembly, the user installs both the cross members 22 and the base spreader portion 56. The illustrated base spreader portion 56 is formed by bending sheet metal such as, for example, 16 gauge steel but it is noted that any suitable material and/or forming method can alternatively be utilized. It is noted that with the single base member 18A being a single rigid component, the feet 30 can be non-leveling feet if desired. It is also noted that the single base member 18A can alternatively have any other suitable configuration.

The illustrated rod assemblies 20 are inverted so that the center supports 38 are secured to the base member portion 18 and the end supports 36 are secured to the platform member 12. As a result, the plurality of pairs of fastener openings 42 for the end supports 36 are located on the platform members 12 and the pairs of fastener openings 50 for the center supports 38 are located on the base member portions 18. The inverted supports 36, 38 illustrate that the rod assemblies 20 can alternatively have either orientation

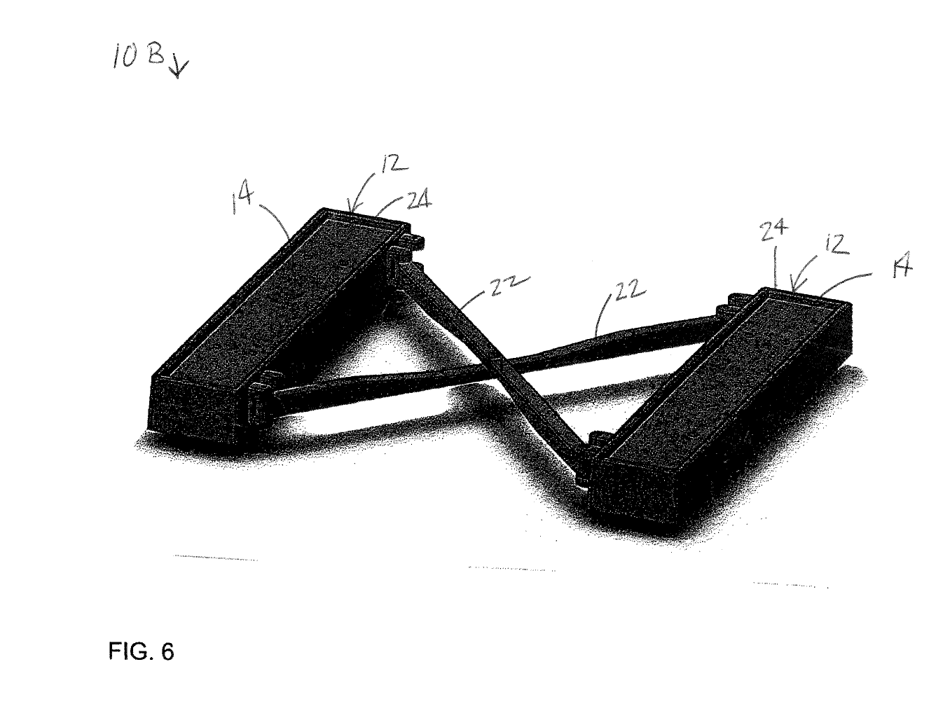

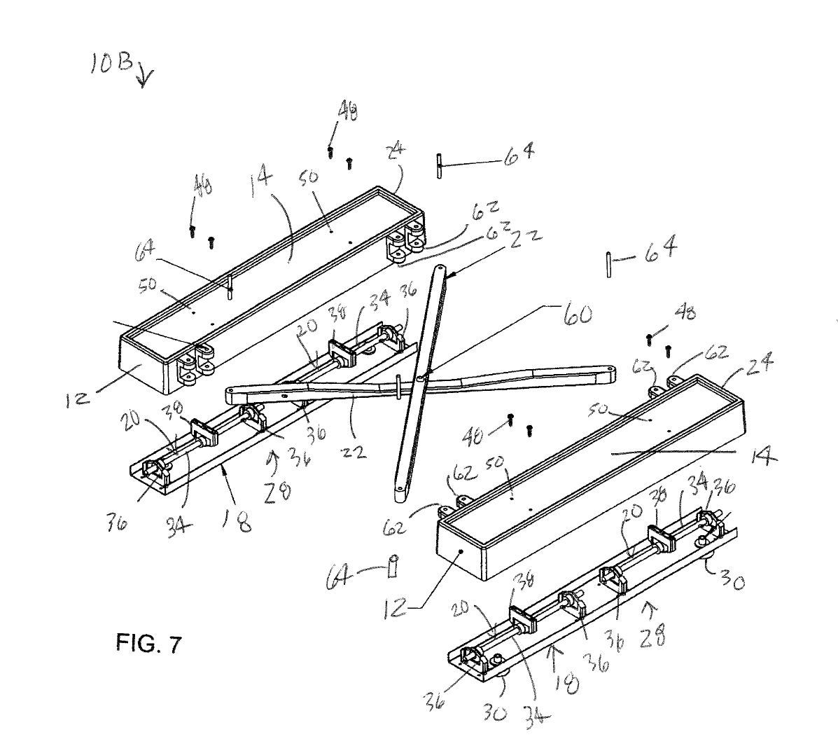

FIGS. 6 and 7 illustrate a vibration-isolator platform 10B according to a second embodiment of the present invention which is substantially the same as the vibration-isolator platform 10 according to the first embodiment of the present invention described above except that the illustrated cross members 22 are rigid bars crossing each other in an X configuration each secured at alternative mounting positions on the base members 18 to provide the desired separation distance from a plurality of available distances between the platform members and thus a desired lateral width of the vibration-isolator platform 10B. Thus, the width of the vibration-isolator platform 10B can be changed by securing the ends of the cross members 22 at different mounting locations. For example, a first mounting location can be provided for adapting the vibration-isolator platform for use with a 24 inch washing machine and a second mounting location can be provided for use with a 27 inch washing machine.

The illustrated cross members 22 have a fixed length and can have any suitable cross-sectional shape. The cross members 22 can be formed of any suitable material. The centers of the cross members 22 are joined by a riveted pin 60 which permits the cross members to pivot relative to one another. Ends of the illustrated pair of cross members 22 are secured to longitudinally spaced-apart mounting positions on the inner wall of platform members 12 so that the cross members are in an X-shaped configuration to rigidly connect the pair of platform members 12 and provide a desired lateral width for the platform 10B. The illustrated mounting positions include a pair of horizontally extending and vertically spaced-apart flanges 62 configured to receive an end of one of the cross members 22 there between The illustrated cross members 22 are rigidly secured to the flanges 62 with a locking pin 64 vertically extending between both flanges 62 and the cross member 22 but can be secured in any other suitable manner. The illustrated platform members 12 each have a first pair of longitudinally spaced-apart mounting positions and a second pair of longitudinally spaced-apart mounting positions such that first pair of mounting positions are spaced apart a distance greater than the distance between the second pair of mounting positions. Thus when the cross members 22 are mounted to the first pair of mounting positions the width of the vibration-isolator platform 10B is less than when the cross members 22 are mounted to the second pair of mounting positions. The illustrated first and second pairs of mounting positions are configured to provide widths suitable for 24 inch and 27 inch washing machines respectively. It is noted that any other suitable quantity and/or configuration for the cross members 22 can be alternatively utilized.

The illustrated vibration-isolator 10B is preferably stored and shipped with at least the rear locking pins 64 removed so that the cross members 22 can be pivoted to collapse the platform members 12 together in a side-by side manner to reduce the size necessary for the container. During assembly, the user pivots the cross members 22 to the desired mounting positions and inserts the locking pins 64.

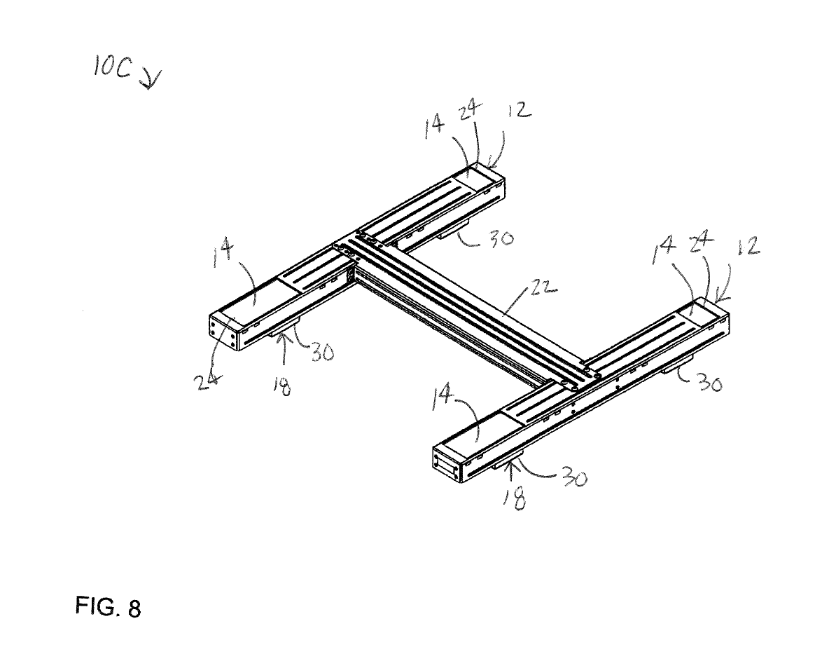

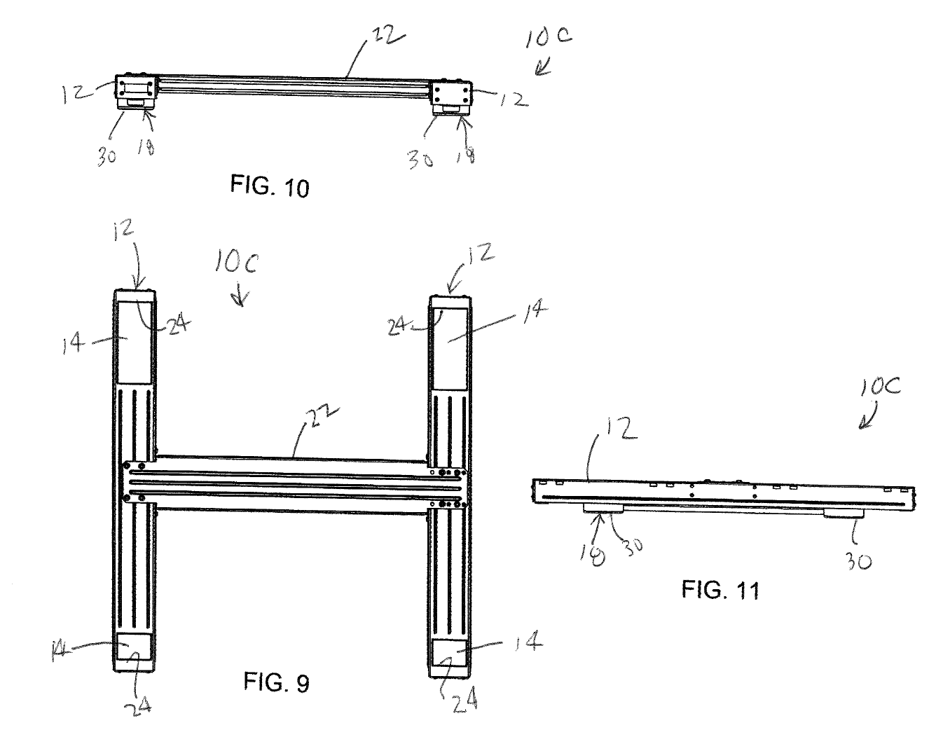

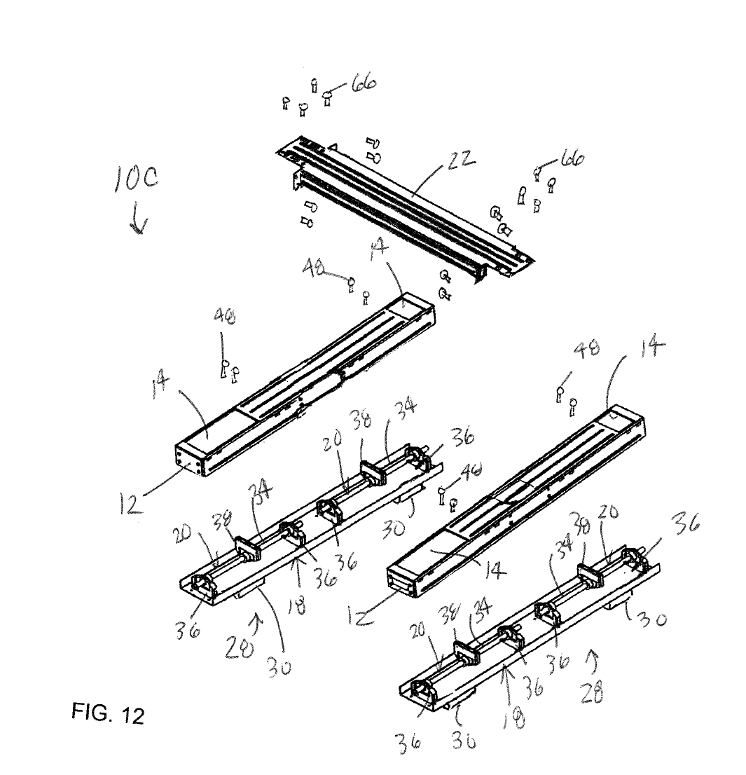

FIGS. 8 to 13 illustrate a vibration-isolator platform 10C according to a third embodiment of the present invention which is substantially the same as the vibration-isolator platform 10 according to the first embodiment of the present invention described above except that the illustrated platform members 12 are formed by bent sheet metal and that there is a single cross member 22 that is formed by bent sheet metal.

The illustrated platform members 12 each have a shape substantially as described above but are formed by bending sheet metal. Additionally each of the platform members 12 have two separate upward-facing support surfaces 14 that are longitudinally spaced apart so that each foot of the washing machine is supported in a separate one of the support surfaces 14. The support surfaces 14 are also each lower than the surrounding upper wall to form recesses or wells that secure the washing machine foot within the wells and on the support surfaces 14 during vibration of the washing machine. The forward one of the illustrated support surfaces 14 has a longitudinal length greater than the rearward one of the support surfaces 14 so that smaller support surface 14 limits movement of the washing machine relative to the vibration-isolator platform in the longitudinal direction while the larger support surface 14 permits a wider range of distances between the washing machine feet in the longitudinal direction. It is noted that alternatively the rear support surface 14 could be larger than the front support surface 14 or the support surfaces 14 could alternatively be the same size. The illustrated platform members 12 are formed of a metal such as, for example, 16 gauge steel. It is noted that the platform members 12 can alternatively have any other suitable configuration.

The illustrated cross member 22 is substantially channel shaped and laterally extends between the platform members 12 at the longitudinal center of the platform members 12 to rigidly connect the platform members together. The illustrated cross member 22 has a horizontally-extending main wall having a length that laterally extends across the top of the platform members, a vertically-extending front wall that downwardly extends from a front edge of the main wall and has a length that laterally extends between the inner walls of the platform members, and a vertically-extending rear wall that downwardly extends from a rear edge of the main wall and has a length that laterally extends between the inner walls of the platform members. The lateral ends of the front wall are each provided with a vertically-extending front flange that forwardly extends from the outer edges of the front wall adjacent to the inner walls of the platform members 12. The lateral ends of the rear wall are each provided with a vertically-extending rear flange that rearwardly extends from the outer edges of the rear wall adjacent to the inner walls of the platform members 12. The illustrated cross member 22 is secured to the platform members 12 with threaded fasteners 66 such as, for example, sheet metal screws extending through the main wall to the top wall of the platform members 12, and through the front and rear flanges to the inner walls of the platform members 12. The illustrated cross member 22 has a fixed length which is sized to provide the desired separation distance between the platform members 12 and thus a desired lateral width of the vibration-isolator platform 10C. Thus, the width of the vibration-isolator platform 10C can be changed by installing a cross member 22 of a different length. For example, cross member 22 having a first length can be provided for adapting the vibration-isolator platform 10C for use with a 24 inch washing machine and cross member 22 having a second length (longer than the first length) can be provided for use with a 27 inch washing machine. The illustrated cross member 22 is formed of a metal such as, for example, 16 gauge steel. It is noted that the cross member 22 can alternatively have any other suitable configuration.

The illustrated vibration-isolator 10C is preferably stored and shipped with the cross member 22 unattached to reduce the size necessary for the container. During assembly, the user attaches the cross member to the platform members by installing the threaded fasteners 66. The front loading washing machine is then placed on top of the platform members 12 with each foot of the washing machine on a different one of the four support surfaces 14 and the spinning axis extending in the forward/rearward direction parallel with the longitudinal axes of the elongate flexible rods 34 of the rod assemblies 20 (best shown in FIG. 13).

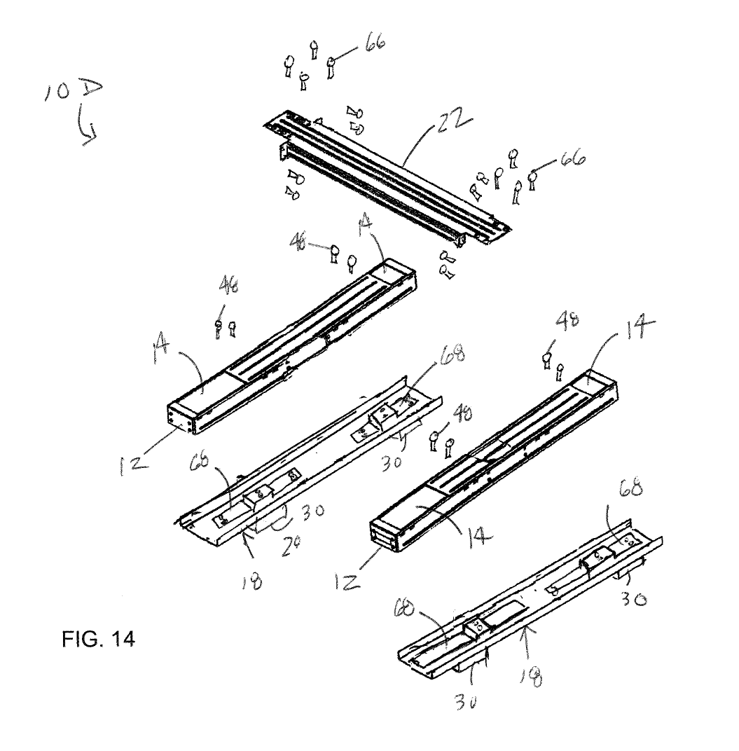

FIGS. 14 and 15 illustrate a platform 10D according to a fourth embodiment of the present invention which is substantially the same as the vibration-isolator platform 10C according to the third embodiment of the present invention described above except that the rod assemblies 20 are removed and the platform members 12 are rigidly secured to the base members 18. Thus, this platform assembly 10D does not provide the same vibration isolation as the vibration isolator platform 10C but this platform 10D can support a device such as a clothes dryer 17 at the same height and with the same look that the vibration isolator platform 10C supports the washing machine 16 to give the same appearance for the washing machine 16 and the dryer 17 when they are used side by side. The platform members 12 can rigidly secured to the base members 18 in any suitable manner such as the illustrated bracket or block 68 that is secured at the same locations as the rod assemblies 20 so that common components can be utilized.

It is noted that each of the features of the various disclosed embodiments of the present invention can be utilized in any combination with each of the other disclosed embodiments of the present invention.

From the above disclosure it can be appreciated that the platforms according to the present invention can provide substantial weight reduction compared to prior art platforms while providing suitable performance. It can also be appreciated that the platforms according to the present invention prove substantial size reduction during shipping and storage compared to prior art platforms because they are collapsible by removing the cross members.

The preferred embodiments of this invention can be achieved by many techniques and methods known to persons who are skilled in this field. To those skilled and knowledgeable in the arts to which the present invention pertains, many widely differing embodiments will be suggested by the foregoing without departing from the intent and scope of the present invention. The descriptions and disclosures herein are intended solely for purposes of illustration and should not be construed as limiting the scope of the present invention.

What is claimed is:

1. A platform comprising:
a pair of paced-apart platform members each having at least one upward-facing support surface;
at least one base member configured to rest on a generally horizontal support surface and to support the pair of platform members; and
at least one cross member extending between the pair of platform members and fixed to each of the pair of platform members to fix a separation distance between the platform members.

2. The platform of claim 1, wherein the pair of platform members are each secured to the at least one base member with a plurality of rod assemblies, wherein each of the rod assemblies comprises an elongate flexible rod having opposing end portions and a central portion intermediate the end portions, a pair of end supports engagingly supporting the end portions of the elongate flexible rod, and a center support engagingly supporting the central portion of the elongate flexible rods; and wherein the end supports are secured to one of the base member and the platform member and the central support is secured to the other of the base member and the platform member.

3. The platform of claim 1, wherein the pair of platform members are each rigidly secured to the at least one base member.

4. The platform of claim 1, wherein there is a pair of the base members and each of the pair of base members is associated with a different one of the platform members.

5. The platform of claim 1, wherein there is only one base member and each of the platform members are secured to the base member.

6. The platform of claim 1, wherein there is a pair of the cross members and each extends between the pair of paced-apart platform members.

7. The platform of claim 1, wherein there is only one cross members that extends between the pair of paced-apart platform members.

8. A vibration-isolator platform for supporting a vibration source, comprising:
a pair of laterally spaced-apart platform members each having at least one upward-facing support surface for partially supporting the vibration source;
at least one base member configured to rest on a generally horizontal support surface and to support the pair of platform members with a plurality of rod assemblies;
wherein the plurality of rod assemblies operably connect the platform members to the at least one base member and are configured to substantially isolate the at least one base member from vibration at the platform members; and
at least one cross member extending between the pair of platform members and fixed to each of the pair of platform members to fix a separation distance between the platform members.

9. The vibration-isolator platform of claim 8, wherein each of the rod assemblies comprises an elongate flexible rod having opposing end portions and a central portion intermediate the end portions, a pair of end supports engagingly supporting the end portions of the elongate flexible rod, and a center support engagingly supporting the central portion of the elongate flexible rods; and wherein the end supports are secured to one of the base member and the platform member and the central support is secured to the other of the base member and the platform member.

10. The vibration-isolator platform of claim 9, wherein the elongate flexible rods are each horizontally disposed and extending in a forward/rearward direction.

11. The vibration-isolator platform of claim 8, wherein there is a pair of the base members and each of the pair of base members is associated with a different one of the platform members.

12. The vibration-isolator platform of claim 8, wherein there is only one base member and each of the platform members are secured to the base member.

13. The vibration-isolator platform of claim 8, wherein there is a pair of the cross members and each extends between the pair of paced-apart platform members.

14. The vibration-isolator platform of claim 8, wherein there is only one cross members that extends between the pair of paced-apart platform members.

15. A vibration-isolator platform in combination with a front-loading washing machine, comprising:
the front-loading washing machine having a horizontally disposed spinning axis; and
the vibration-isolator platform comprising:
a pair of laterally spaced-apart platform members each having at least one upward-facing support surface for partially supporting the front-loading washing machine;
at least one base member configured to rest on a generally horizontal support surface and to support the pair of platform members with a plurality of rod assemblies;
wherein the plurality of rod assemblies operably connect the platform members to the at least one base member and are configured to substantially isolate the at least one base member from vibration at the platform members; and
at least one cross member extending between the pair of platform members and fixed to each of the pair of platform members to fix a separation distance between the platform members.

16. The vibration-isolator platform and front-loading washing machine of claim 15, wherein each of the rod assemblies comprises an elongate flexible rod having opposing end portions and a central portion intermediate the end portions, a pair of end supports engagingly supporting the end portions of the elongate flexible rod, and a center support engagingly supporting the central portion of the elongate flexible rods; and wherein the end supports are secured to one of the base member and the platform member and the central support is secured to the other of the base member and the platform member.

17. The vibration-isolator platform and front-loading washing machine of claim 16, wherein the elongate flexible rods are each arranged in substantially parallel relationship with the spinning axis.

18. The vibration-isolator platform and front-loading washing machine of claim 15, wherein there is a pair of the base members and each of the pair of base members is associated with a different one of the platform members.

19. The vibration-isolator platform and front-loading washing machine of claim 15, wherein there is only one base member and each of the platform members are secured to the base member.

20. The vibration-isolator platform and front-loading washing machine of claim 15, wherein there is only one cross members that extends between the pair of paced-apart platform members.
